(19) United States
(12) Patent Application Publication
(10) Pub. No.: US 2021/0121972 A1
(43) Pub. Date: Apr. 29, 2021

(54) WELDING MACHINE AND RELATIVE METHOD

(71) Applicant: DANIELI & C. OFFICINE MECCANICHE S.P.A., Buttrio (IT)

(72) Inventors: Andrea Trinco, Pradamano (IT); Claudio Tomat, Premariacco (IT)

(21) Appl. No.: 17/077,420

(22) Filed: Oct. 22, 2020

(30) Foreign Application Priority Data
Oct. 24, 2019 (IT) 102019000019750

(51) Int. Cl. B23K 11/04; B23K 37/02; B23K 37/04

(52) U.S. Cl. CPC B23K 11/046; B23K 37/0435; B23K 37/0294

(57) ABSTRACT

A welding machine for welding together the tail of a billet to the head of a second billet along a feeding direction, the machine comprising a carriage adapted to slide along the feeding direction, said carriage supporting a first structure integrally fixed to said carriage; first clamping means, provided on said first structure, for clamping the head of the second billet; a second structure connected to the first structure and sliding, parallel to the feeding direction, with respect to both the first structure and the carriage; second clamping means, provided on said second structure, for clamping the tail of the first billet; wherein first adjustment means are provided for adjusting the position of the second structure with respect to the first structure along said feeding direction; and second adjustment means are provided for adjusting the position of the second structure with respect to the first structure on a plane transversal to the feeding direction, so as to align the second clamping means with the first clamping means along said feeding direction.

### CROSS-REFERENCE TO RELATED APPLICATIONS

This application claims priority to Italian Patent Application No. 102019000019750 filed on Oct. 24, 2019, the disclosure of which is expressly incorporated herein by reference.

### STATEMENT RE: FEDERALLY SPONSORED RESEARCH/DEVELOPMENT

Not applicable.

### FIELD OF THE INVENTION

The present invention relates to a welding machine of the flash welding type for longitudinal metal products, for example billets, bars or blooms, suitable for welding head and tail of two consecutive longitudinal products along a roller table, which is usually arranged upstream of a rolling mill. The invention also relates to a welding method, which can be performed by means of the aforesaid machine.

### BACKGROUND ART

In rolling mills, in particular, of the endless operating type, metal products from the casting machine or from external warehouses are welded together and then rolled.

Metal products, which are welded, are typically semi-finished metal products, such as billets, bars or booms.

The welding is carried out by joining the tail of one product to the head of the successive product.

Welding is achieved by means of an electric shock produced by power supplies, which supply the products to be welded. This technology is known as flash welding.

During welding the products must be effectively locked. To this end, clamping means are provided, which serve to keep the products in place during the welding and often to transmit the electric current to the products to be welded.

Such clamping means typically comprise elements, in particular clamps, which come directly into contact with the products to be welded. As the welding is gradually carried out, the clamps, which hold the head and tail of the products to be welded, are brought close by means of cylinders, referred to as upsetting cylinders. This operation is necessary to compensate the loss of material caused by the melting and to allow the effective adhesion between the two components being welded, which form a joint. However, a string of burr is formed around the joint, due to the outward expulsion of the molten material during welding, which must be removed (or reduced), if in excess, so as not to cause problems during rolling.

Disadvantageously, known welding machines are not capable of perfectly aligning the head and tail of the two products to be welded.

Often, the head and tail of the two products reach the welder folded, for example, because of conduction in the heating furnace (RHF) and/or due to the fact that the welding machine itself folds or misaligns the billets as a result of the wear of the clamps, the dirty state thereof, or an incorrect assembly thereof.

This causes steps or depressions in the welded joint, making it difficult to clean in the successive machinings, also causing further difficulties in the successive rolling.

Thus, the need is felt to overcome the stated drawbacks.

### SUMMARY OF THE INVENTION

It is an object of the present invention to produce a welding machine of the flash welding type provided with an effective aligning system for aligning the head and tail of the two products to be welded.

It is another object of the present invention to produce a welding machine provided with an aligning system, which is simple from a structural point of view, and which nonetheless allows to perform the necessary movements of the known welding machines.

It is a further object of the present invention to produce a welding machine provided with an automatic aligning system, which allows increased operator safety.

The present invention achieves at least one of such objects, and other objects, which will become clear in the light of the present description, by means of a welding machine of the flash welding type for welding the tail of a first longitudinal metal product to the head of a second longitudinal metal product along a feeding direction of said longitudinal metal products, the machine comprising a carriage adapted to slide along the feeding direction, said carriage supporting
a first structure fixed to said carriage;
first clamping means, provided on said first structure, for clamping the tail of the first metal product or the head of the second metal product;
a second structure connected to said first structure so as to slide, parallel to the feeding direction, with respect both to the first structure and the carriage;
second clamping means, provided on said second structure, for clamping the head of the second metal product or the tail of the first metal product;

wherein first adjustment means are provided for moving the second structure close to, or away from the first structure along said feeding direction;

and wherein second adjustment means are provided for adjusting, along a plane transversal to said feeding direction, the position of the second structure with respect to the first structure by means of a lifting of the second structure, in order to align said head and said tail.

According to a further aspect of the invention, a welding method of the flash welding type is provided for welding the tail of a first longitudinal metal product to the head of a second longitudinal metal product fed along a feeding direction of said longitudinal metal products, the method being performable by means of the aforesaid machine and comprising the following steps:

a) clamping the tail of the first metal product or the head of the second metal product by means of first clamping means provided on said first structure, and clamping the head of the second metal product or the tail of the first metal product by means of second clamping means provided on said second structure;

b) adjusting, by means of said second adjustment means, the position of the second structure with respect to the first structure by means of a lifting of the second structure along a plane transversal to said feeding direction, so as to align said tail and said head;

c) welding said tail and said head by moving the second structure close to the first structure along said feeding direction, by means of said first adjustment means.

Advantageously, the welding machine of the invention is provided with an aligning system designed to lift, when required, the head of the metal product, for example a billet, entering the machine (or vice versa the tail of the metal product exiting the machine), so as to align the two head and tail surfaces with the same position.

In particular, the two structures or parts of the welding machine, one, which retains the tail of a first product, and the other, which retains the head of a second product, are slidably constrained to each other by means of beams: one part of the machine is fixed to the carriage, instead, the other part is suspended in a cantilever manner by means of the beams.

In one embodiment of the invention, the lifting of the clamping means of the cantilevered suspended part occurs by means of a pushing device, for example a hydraulic system, which causes a roller to rotate, which is mounted onto an eccentric portion of a rotating shaft and which is in contact with the lower cantilevered beam.

In a variant of the invention, due to a particular configuration of the sliding rollers of the structure or movable part, i.e. the slidable and liftable part of the machine which is not integrally constrained to the carriage, said sliding rollers allow the movable part to slide with respect to the fixed part, and the aforesaid movable part can be lifted by means of a slight rotation upwards about a horizontal rotation axis, causing a lifting of the clamping means of the movable part until the head and tail of the two metal products are aligned. In fact, the slight movement of the movable part along an arc-of-a circle, causes a substantially vertical movement of the metal product, for example a billet, which is sustained by said movable part.

In a further variant, this lifting is facilitated by a particular configuration of the upsetting cylinder ends.

In another variant of the invention, at least one sensor is provided, for example a camera, a probe, a laser sensor or another suitable sensor, adapted to detect the difference in height between the position of the head of the metal product entering the welding machine with respect to the tail of the preceding metal product. A software acquires the value of this difference in height and sends a command to the second adjustment means to adjust the position of the movable part with respect to the fixed part by means of an oscillation along a plane, which is transversal, preferably orthogonal, to the feeding direction of the metal products.

In the case of using a camera, it is possible to transmit the images to a monitor, allowing an operator, at a safe distance from the machine, to check the alignment of the metal products, and thus, the centering position of the welding joint.

Further features and advantages of the invention will become more apparent in light of the detailed description of exemplary but not exclusive embodiments.

The dependent claims describe particular embodiments of the invention.

### BRIEF DESCRIPTION OF THE FIGURES

Reference is made to the accompanying drawing tables in the description of the invention, which is provided by way of a non-limiting example, in which:

FIG. 1 shows a first side view of a first embodiment of the welding machine according to the invention;

FIG. 2 shows a second side view of the machine in FIG. 1;

FIG. 3a shows a third side view of the machine in FIG. 1;

FIG. 3b shows the aforesaid third side view in a different operating position;

FIG. 4 shows a cross-section along a plane A-A of the machine in FIG. 3a;

FIG. 5 shows an enlargement of a first part in FIG. 4;

FIG. 6 shows an enlargement of a second part in FIG. 4;

FIG. 7 shows a view from above of the machine in FIG. 1;

FIG. 8 shows a cross-section of a component of the machine in FIG. 3b;

FIG. 9 shows a side view of a second embodiment of the welding machine according to the invention.

The same numerals and letters of reference in the figures identify the same elements or components.

### DESCRIPTION OF EXEMPLARY EMBODIMENTS OF THE INVENTION

Some examples of a welding machine of the flash welding type according to the invention are illustrated with reference to the Figures.

In all of the embodiments of the invention, the welding machine, which is suitable for welding the tail of a first longitudinal metal product to the head of a second longitudinal metal product along a feeding direction of said longitudinal metal products, comprises a carriage 1, adapted to slide along said feeding direction above a roller table (not shown) on which the longitudinal metal products, such as billets, blooms or bars, advance.

The carriage 1 supports:
a first structure, or body, 2 connected, for example fixed, to said carriage 1;
first clamping means 3, 4, provided on the first structure 2, for clamping the tail of the first metal product, or the head of the second metal product;
a second structure, or body, 5 connected to the first structure 2 so as to slide, parallel to the feeding direction, with respect both to the first structure 2 and the carriage 1;
second clamping means 6, 7, provided on the second structure 5, for clamping the head of the second metal product, or the tail of the first metal product;
first adjustment means 22, 23 for moving the second structure 5 close to, or away from the first structure 2 along the feeding direction, i.e. to adjust the distance of the second structure 5 from the first structure 2 along said feeding direction.

The first structure 2 is fixed to the carriage 1 by means of at least one constraint 33, preferably only one constraint. The constraint 33 can allow a slight oscillation of the first structure 2 thereabout. Thus, the second structure 5, also being connected to the first structure 2, can oscillate slightly about the constraint 33.

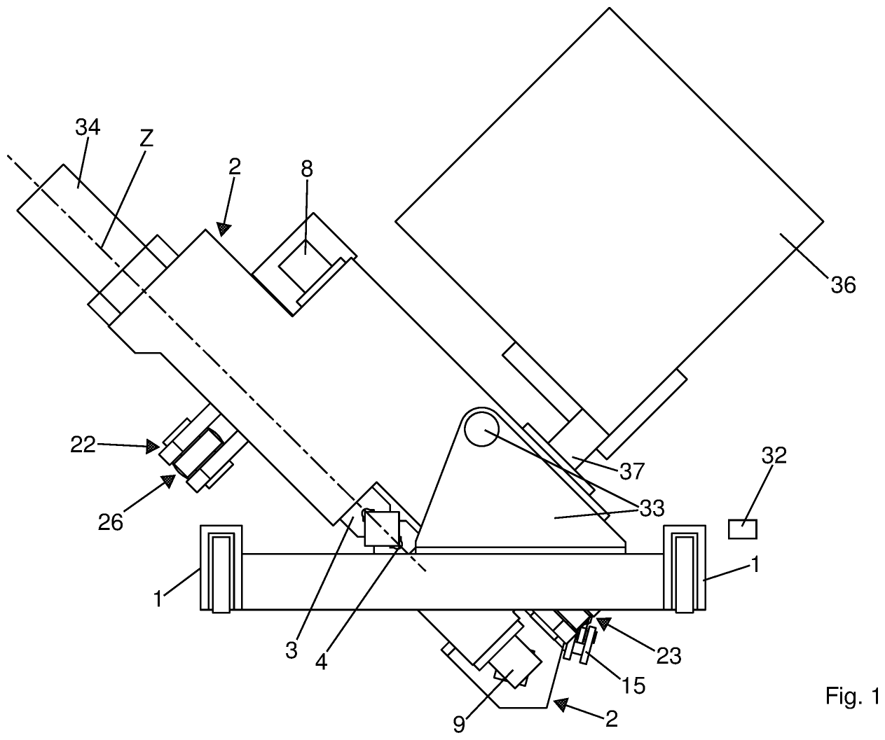

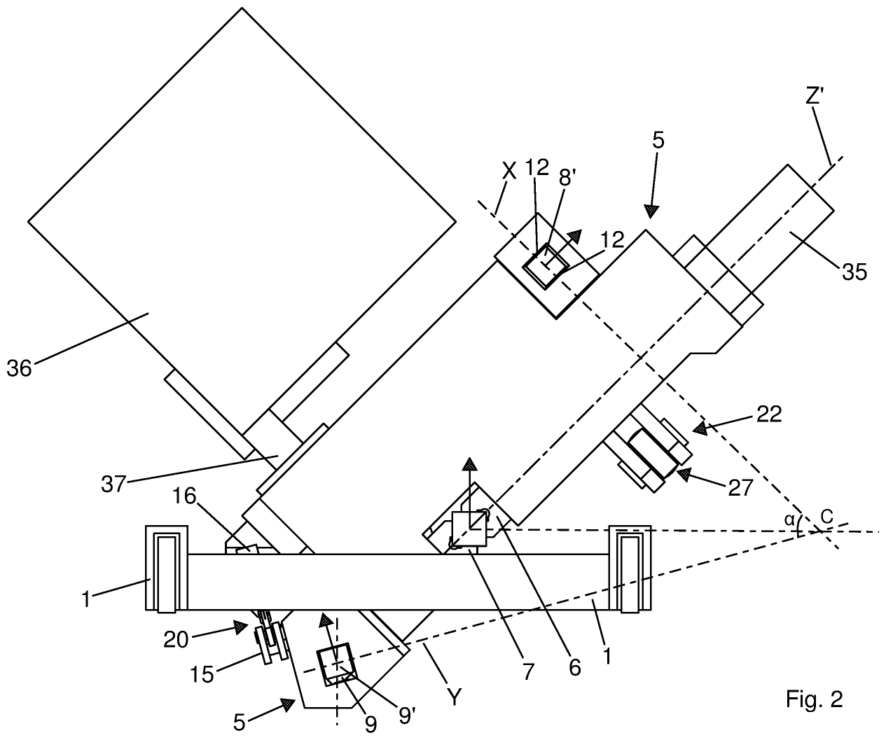

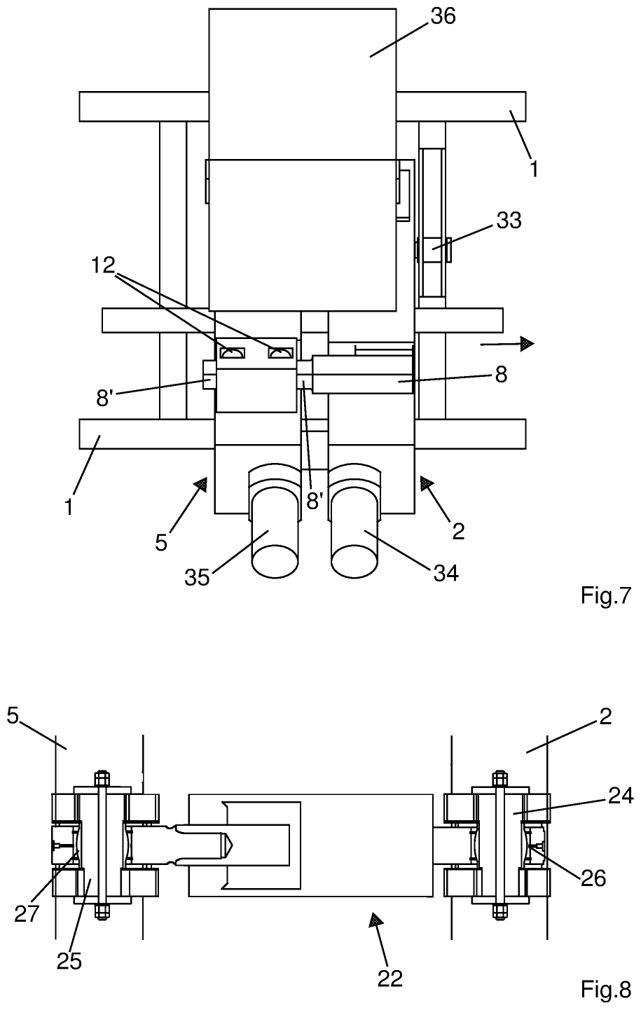

In a first embodiment of the welding machine, shown in FIGS. 1-8, the first structure 2 defines a longitudinal axis Z (FIG. 1), which is inclined, with respect to the horizontal plane defined by the carriage 1, by an acute angle, preferably between 30° and 50°, for example 45°. The second structure 5, defining a longitudinal axis Z′ thereof (FIG. 2), is arranged substantially parallel to the first structure 2 and spaced apart from the latter along the feeding direction of the products to be welded.

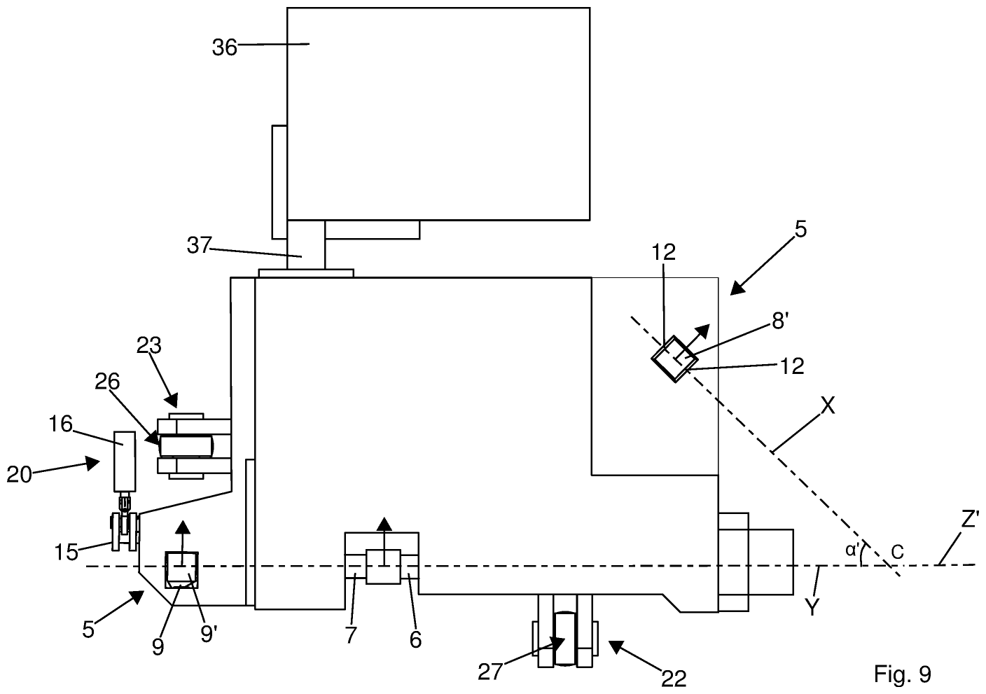

In a second embodiment of the welding machine, shown in FIG. 9, the first structure 2 defines a substantially horizontal longitudinal axis Z (not shown). Similarly, the second structure 5, defining a longitudinal axis Z′ thereof (FIG. 9), is arranged substantially parallel to the first structure 2 and spaced apart from the latter along the feeding direction of the products to be welded.

In all of the embodiments, the first clamping means 3, 4 of the first structure 2 comprise respective upper clamps and lower clamps. While the lower clamps are fixed clamps, the upper clamps can be moved by a respective movement cylinder 34 (FIG. 1).

The second clamping means 6, 7 of the second structure 5 comprise respective upper clamps and lower clamps. In this case, too, while the lower clamps are fixed clamps, the upper clamps can be moved by a respective movement cylinder 35 (FIGS. 2 and 9).

Alternatively, it is nonetheless also possible to make the lower clamps movable.

The welding machine is provided with a transformer 36 and conductors 37 connected to the structure 2 and to the structure 5, respectively, to supply current, in a known manner, to the products to be welded.

Advantageously, second adjustment means are provided, for adjusting the position of the second structure 5 with respect to the first structure 2 by means of a lifting of the second structure 5 along a plane transversal, preferably orthogonal, to said feeding direction, so as to align the tail and the head of the two products along the feeding direction. This lifting can occur by means of a slight rotation of the second structure 5 about a rotation axis C parallel to the feeding direction (FIGS. 2 and 9). In the first embodiment (FIG. 2) said rotation axis C is preferably arranged on the side opposite to the side where the transformer 36 is present (FIG. 2).

In particular, the second structure 5 is connected in a cantilever manner to the first structure 2, said second structure 5 being sliding on at least two supports 8, 9, preferably cantilevered beams, fixed to the first structure 2 and having longitudinal axes parallel to each other and to the feeding direction of the products.

Preferably, the second adjustment means are integrated into the second structure 5 and comprise a pushing device 20 configured to push on at least one of the cantilevered beams 8,9 to lift the second structure 5 slightly with respect to the first structure 2.

In the embodiments shown in the Figures, only one first cantilevered beam 8 and one second cantilevered beam 9 are provided, fixed to a first end and to a second end of the first structure 2, respectively.

Optionally, the first end of the second structure 5 (which is the upper end in the case of the welding machine being inclined in FIG. 2) can be slidably connected to a first end of the first structure 2 by means of the first cantilevered beam 8, or upper cantilevered beam. Whereas, the second end of the second structure 5 (which is the lower end in the case of the welding machine being inclined in FIG. 2) can be slidably connected to a second end of the first structure 2 by means of the second cantilevered beam 9, or lower cantilevered beam.

Therefore, the second structure 5 is sliding on the upper and lower cantilevered beams 8, 9 so as to move close to, or away from, the first structure 2.

Preferably, the pushing device 20 is configured to push on the lower cantilevered beam 9 to lift the second structure 5.

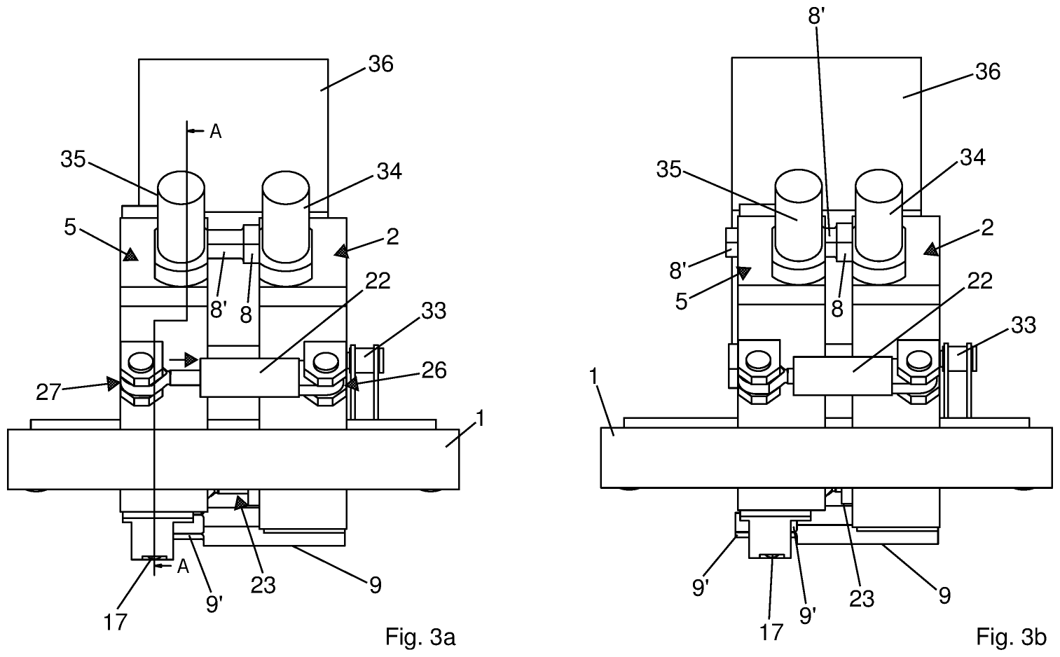

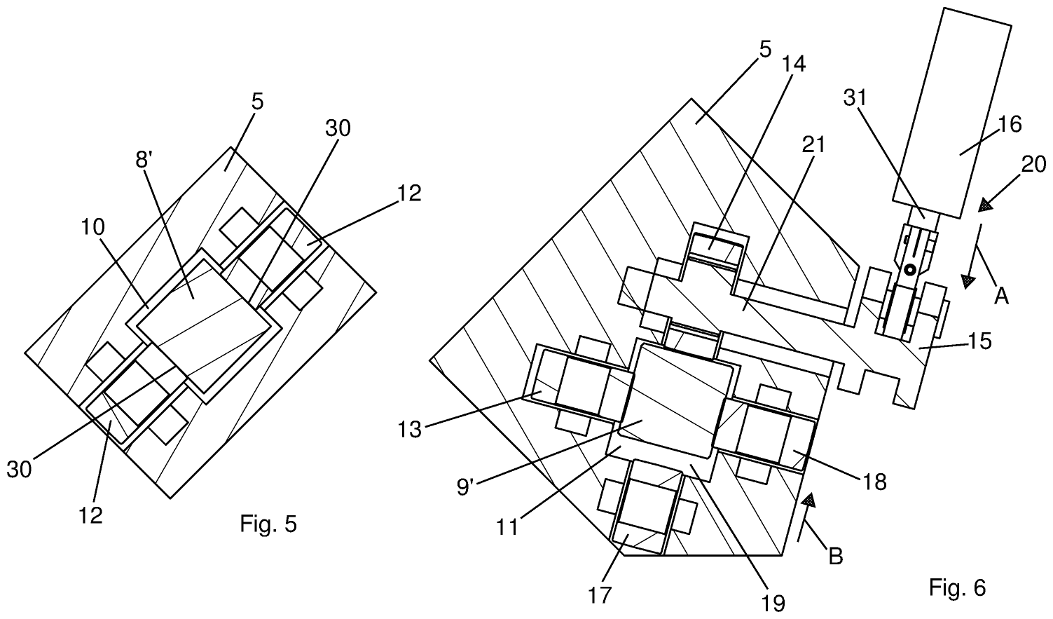

As shown in the variant in FIGS. 3a and 3b, but which can be valid for both embodiments described herein, the upper cantilevered beam 8 has a first portion 8′ thereof having a quadrangular section, which is distal from the first structure 2 and inserted into a through hole 10 (FIG. 5), having a quadrangular section, of the second structure 5. Preferably, the upper cantilevered beam 8 has a second portion thereof that is proximal and fixed integrally to the first structure 2, while the first portion 8′ is cantilevered and, optionally, there is provided a shoulder between said first portion 8′ and the adjacent second portion. Optionally, also the second portion of the cantilevered beam 8 has a quadrangular section, and, preferably, the side surfaces of said second portion are parallel to the corresponding side surfaces of the first portion 8′.

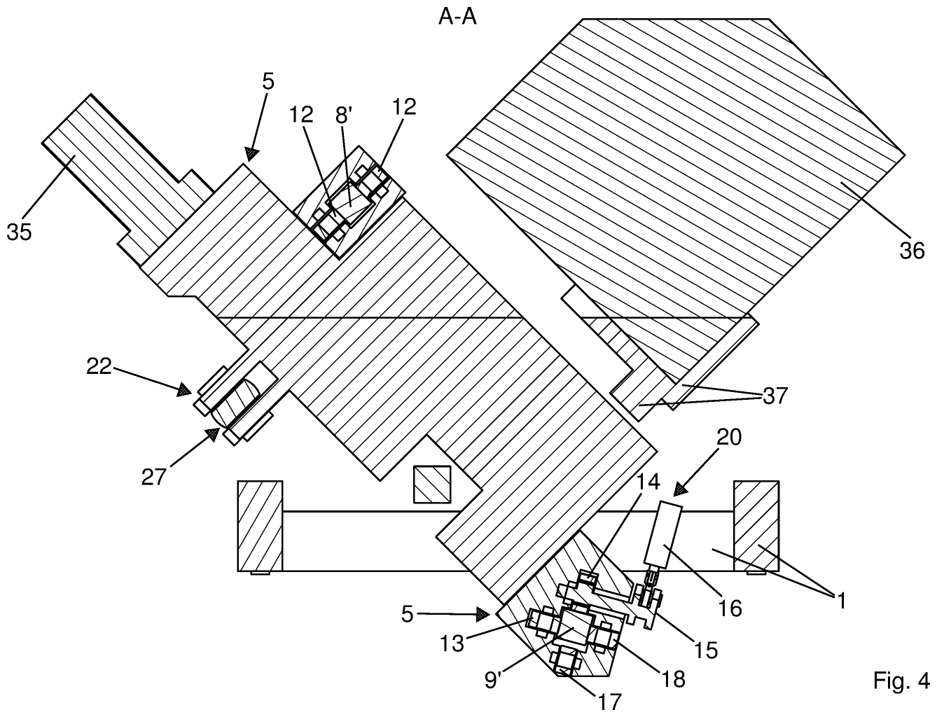

The through hole 10 is provided, on at least two opposite side surfaces, with first rollers 12 (FIGS. 4 and 5) for a sliding of the second structure 5 on the cantilevered beam 8, in particular on the portion 8′ thereof.

Preferably, a pair of first rollers 12 is provided on each of said two opposite side surfaces of the through hole 10. It is not excluded that only one roller 12, or three or more rollers 12, can be provided, on each of said two opposite side surfaces, inside the through hole 10.

Advantageously, the first rollers 12 have a convex side surface 30, i.e. slightly convex, in contact with a respective side surface of the upper cantilevered beam 8 to facilitate a small rotation, about the axis C, of the second structure 5 along a plane, which is transversal, preferably orthogonal, to the feeding direction.

The first rollers 12 are idle rollers, accommodated in respective seats obtained in the second structure 5, i.e. seats obtained in said two inner and opposite side surfaces of the through hole 10. Such rollers 12 protrude slightly into said through hole 10 to come into contact with mutually opposite surfaces of the upper cantilevered beam 8.

Similarly, the lower cantilevered beam 9 has a first portion 9′ thereof having a quadrangular section, distal from the first structure 2 and inserted into a through hole 11 (FIG. 6), having a quadrangular section, of the second structure 5. Preferably, the lower cantilevered beam 9 has a second portion thereof which is proximal and fixed integrally to the first structure 2, while the first portion 9′ is cantilevered and, optionally, there is provided a shoulder between said first portion 9′ and the adjacent second portion. Optionally, also the second portion of the cantilevered beam 9 has a quadrangular section, and preferably the side surfaces of said second portion are not parallel to the corresponding side surfaces of the first portion 9′ (FIG. 3a).

Alternatively, the shape of the cross-section of the first portion 9′ of the lower cantilevered beam 9 can be different from quadrangular, for example round.

In a variant, the through hole 11 is provided with four second rollers 13, 14, 17, 18. Each second roller 13, 14, 17, 18 is arranged at a respective inner side surface of the through hole 11, for a sliding of the second structure 5 on the cantilevered beam 9.

In particular, each second roller 13, 14, 17, 18 is accommodated in a respective seat obtained in the second structure 5, i.e. in a respective seat obtained in a corresponding inner side surface of the through hole 11, and protruding into said through hole 11 for possibly coming into contact with a respective side surface of the lower cantilevered beam 8. The two side rollers 13, 18 and the lower roller 17 are idle rollers, while the upper roller 14 is a controlled roller, which however is idle on rotation.

Advantageously, the upper roller 14 of said four second rollers is mounted on an eccentric portion of a rotating shaft 21, and the pushing device 20 is adapted to rotate said rotating shaft 21 so that the upper roller 14, protruding more from the seat thereof, pushes on the underlying lower cantilevered beam 9 in order to lift the second structure 5.

In fact, in a rest position, the first portion 9′ of the lower cantilevered beam 9 is in contact with the upper roller 14, which is in a partially retracted position inside the seat thereof, and in contact with two side rollers 13, 18 of said second rollers, while a gap 19 can be present between the lower roller 17 of said second rollers and the first portion 9′ of the lower cantilevered beam 9.

Whereas, in a thrust position, the upper roller 14 is in a more protruding position from the seat thereof, with respect to the rest position, so that the second structure 5 is lifted until possibly making contact between the lower roller 17 and the first portion 9′.

In an alternative variant, the lower roller 17 is not provided and, in the thrust position, the second structure 5 is lifted without making contact between the lower inner side surface of the through hole 11, i.e. the inner side surface not provided with a roller, and the first portion 9′.

In a preferred variant of the invention, shown in FIG. 6, the pushing device 20 comprises an actuator 16, preferably a hydraulic cylinder, adapted to actuate, for example by means of a stem 31 connected to the piston (not visible), a lever 15 at a first end thereof, said lever 15 being integral at a second end thereof with the rotating shaft 21 onto whose eccentric portion the upper roller 14 is keyed.

Therefore, by actuating the actuator 16, the stem 31 moves downwards along the arrow A lowering the first end of the lever 15 connected to the stem 31 and, thus, causing the second end of the lever 15, for example keyed to the shaft 21, to rotate around the same rotation axis as the shaft 21. In this way, the shaft 21 will rotate, also causing the upper roller 14 to rotate. Preferably, the maximum rotation of the shaft 21 about the axis thereof, and thus the maximum rotation of the upper roller 14, is by an angle of less than, or equal to 180°, for example between 45° to 135°. Following the rotation of the upper roller 14, the latter will be more protruding from the seat thereof, causing a lifting of the lower part of the second structure 5 along the arrow B (FIG. 6) until possibly also bringing the lower roller 17 into contact with the portion 9′ of the lower cantilevered beam 9.

Preferably, as visible in FIGS. 2 and 9, the upper cantilevered beam 8 is configured so that the first portion 8′ thereof has a plane of symmetry X, which is perpendicular to the mutually opposite two side surfaces thereof in contact with the first rollers 12; while the lower cantilevered beam 9 is configured so that the first portion 9′ thereof has a plane of symmetry Y parallel to the side surface thereof in contact with the upper roller 14. The plane of symmetry X and the plane of symmetry Y are incident, defining an axis C, which is parallel to the feeding direction and about which the second structure 5 can rotate slightly. In the first embodiment, shown in FIG. 2, the acute angle a defined by the planes X and Y, in the rest position (i.e. when the second structure 5 is not lifted), can be between 40° and 90°, preferably between 45° and 65°. The rotation of the second structure 5 about the axis C can occur in a range between 1° and 5°, preferably between 1° and 3°.

This rotation is facilitated by the presence of the convex side surface 30 of the first rollers 12 in contact with the respective side surface of the upper cantilevered beam 8.

In one variant, the plane of symmetry X forms an acute angle between 25° and 45° with a horizontal plane defined by the carriage 1; while the plane of symmetry Y forms an acute angle between 15° and 20° with said horizontal plane. The sum of these two acute angles is equal to the acute angle α (FIG. 2).

Furthermore, the axis C is arranged, with respect to the welding machine, on side opposite to where the transformer 36 is present (FIG. 2).

In the second embodiment, shown in FIG. 9, the acute angle α′ defined by the planes X and Y, in the rest position, can be between 5° and 85°, preferably between 30° and 60°. The rotation of the second structure 5 about the axis C can occur in a range between 1° and 5°, preferably between 1° and 3°.

This rotation is facilitated by the presence of the convex side surface 30 of the first rollers 12 in contact with the respective side surface of the upper cantilevered beam 8.

In this embodiment, the plane of symmetry Y is substantially horizontal and, in the rest position, also parallel to the longitudinal axis Z′ of the second structure 5.

Preferably, in both embodiments, the axis C is an axis external to the welding machine, i.e. an axis which does not intersect any component of the welding machine.

Optionally, the first adjustment means are upsetting cylinders 22, 23, preferably only two in number.

The upsetting cylinders 22, 23 are hinged, at a first end thereof, to the first structure 2 and, at a second end thereof, to the second structure 5 by means of respective pins 24, 25. Advantageously, both the first end and the second end of each upsetting cylinder 22, 23 are provided with a respective ball joint 26, 27. These ball joints at the two ends of each upsetting cylinder allow the second structure 5 to be lifted with respect to the first structure 2 fixed to the carriage 1, facilitating a slight inclination of the same upsetting cylinders with respect to the normally horizontal position thereof, which is parallel to the feeding direction of the products.

Preferably, in the variants shown in the Figures, a first upsetting cylinder 22 is arranged at the bottom behind the welding machine, i.e. at the bottom behind both of the first structure 2 and of the second structure 5, on the side opposite to the side on which the upper cantilevered beam 8 is fixed and/or on which the transformer 36 is provided. Instead, the second upsetting cylinder 23 is arranged at one end of the welding machine, for example, at the foot both of the first structure 2 and of the second structure 5 in the case of the variant in FIG. 1. Preferably, in all of the embodiments, the second upsetting cylinder 23 is arranged close to the side opposite to the side on which the first upsetting cylinder 22 is provided.

Preferably, the axes of the pins 24, 25 of the upsetting cylinder 22 define a plane, which is transversal (FIGS. 1 and 9), for example substantially orthogonal, to the plane defined by the axes of the pins of the upsetting cylinder 23.

In one advantageous variant of the invention, at least one sensor 32 is provided, for example a camera, a probe, a laser sensor or another suitable sensor, which is adapted to detect the difference in height between the head of the metal product entering the welding machine and the tail of the preceding metal product. A suitable software acquires the value of said difference in height and sends a command to the second adjustment means, preferably the pushing device 20, to automatically adjust the position of the second structure 5 with respect to the first structure 2.

In the case of using a camera, it is possible to transmit the images to a monitor, allowing an operator, at a safe distance from the machine, to check and adjust the alignment of the metal products, and thus, the centering position of the welding joint.

Described below are the steps of a flash welding method according to the present invention.

The welding method, which can be performed by means of the machine described above, comprises the following steps:

a) clamping the tail of the first metal product or the head of the second metal product by means of first clamping means 3, 4 provided on the first structure 2, and clamping the head of the second metal product or the tail of the first metal product by means of second clamping means 6, 7 provided on the second structure 5;

b) adjusting, by means of the second adjustment means, the position of the second structure 5 with respect to the first structure 2 by means of a lifting, preferably by means of a rotation, of the second structure 5 along a plane transversal to said feeding direction, so as to align the tail and the head along the feeding direction;

c) welding the tail and the head by moving the second structure 5 close to the first structure 2 along said feeding direction, by means of the first adjustment means.

In step b) the rotation of the second structure 5 occurs about the axis C, parallel to the feeding direction, in a range between 1° and 5°, preferably between 1° and 3°.

Preferably, the following steps are comprised between step a) and step b):
detecting a difference in height, by means of at least one sensor 32, between the head of the metal product entering the welding machine and the tail of the preceding metal product;
acquiring the value of said difference in height by means of a software and sending a command to the second adjustment means, to adjust the position of the second structure 5 with respect to the first structure 2.

What is claimed is:

1. A welding machine of the flash welding type for welding a tail of a first longitudinal metal product to a head of a second longitudinal metal product along a feeding direction of said first and second longitudinal metal products, the welding machine comprising a carriage adapted to slide along the feeding direction, said carriage supporting
a first structure fixed to said carriage;
first clamping means, provided on said first structure, for clamping the tail of the first longitudinal metal product or the head of the second longitudinal metal product;
a second structure connected to said first structure so as to slide, parallel to the feeding direction, with respect both to the first structure and the carriage;
second clamping means, provided on said second structure, for clamping the head of the second longitudinal metal product or the tail of the first longitudinal metal product;
wherein first adjustment means are provided for moving the second structure close to, or away from the first structure along said feeding direction;
and wherein second adjustment means are provided for adjusting, along a plane transversal to said feeding direction, a position of the second structure with respect to the first structure by means of a lifting of the second structure, in order to align said tail and said head.

2. The machine according to claim 1, wherein said first adjustment means are upsetting cylinders, preferably only two in number; wherein said upsetting cylinders are hinged at a first end thereof to the first structure and at a second end thereof to the second structure by means of respective pins; and wherein both the first end and the second end of each upsetting cylinder are provided with a respective ball joint.

3. The machine according to claim 1, wherein the second structure is connected to the first structure in a cantilever manner, said second structure being slidable on at least two supports fixed to, and at least partially protruding from, the first structure and having longitudinal axes parallel to each other and to the feeding direction; wherein at least one first portion of a first support of said at least two supports is cantilevered and has at least one plane of symmetry X; wherein at least one first portion of a second support of said at least two supports is cantilevered and has at least one plane of symmetry Y; and wherein the plane of symmetry X and the plane of symmetry Y are incident, thus defining an axis C, parallel to the feeding direction and about which the second structure can rotate.

4. The machine according to claim 3, wherein said second adjustment means are integrated into the second structure and comprise a pushing device configured to push on at least one of the two supports to lift the second structure.

5. The machine according to claim 4, wherein said at least two supports are a first cantilevered beam and a second cantilevered beam, preferably fixed to a first end and a second end of the first structure, respectively; preferably wherein said pushing device is configured to push on said second cantilevered beam to lift the second structure.

6. The machine according to claim 5, wherein the first cantilevered beam has the first portion thereof, having a quadrangular section, which is distal from the first structure and inserted into a first through hole, having a quadrangular section, of the second structure provided, on at least two opposite inner sides, with first rollers for the second structure to slide on said first cantilevered beam, and wherein the plane of symmetry X of the first portion is perpendicular to side surfaces of the first portion in contact with the first rollers; preferably wherein the second cantilevered beam has the first portion thereof, having a quadrangular section, which is distal from the first structure and inserted into a second through hole, having a quadrangular section, of the second structure provided with at least three second rollers, each second roller being arranged at a respective inner side of the second through hole, for the second structure to slide on said second cantilevered beam, and wherein the plane of symmetry Y of the first portion is parallel to the side surface of the first portion in contact with an upper roller of said at least three second rollers;
preferably wherein the upper roller of said at least three second rollers is mounted on an eccentric portion of a rotating shaft and the pushing device is adapted to rotate said rotating shaft so that said upper roller pushes on said second cantilevered beam to lift the second structure.

7. The machine according to claim 6, wherein, in a rest position, the first portion of the second cantilevered beam is in contact with the upper roller, which is in a retracted position inside a seat thereof, and in contact with two side rollers of said second rollers, while a gap is present between a lower inner side of the second through hole and said first portion or between a lower roller of said second rollers and said first portion; and wherein, in a pushing position, the upper roller is in a more protruding position from the seat thereof, with respect to the case of the rest position, so that the second structure is lifted up, preferably lifted up to a possible contact between the lower roller and the first portion.

8. The machine according to claim 6, wherein the first cantilevered beam has a second portion thereof that is proximal and integrally fixed to the first structure, while the first portion is cantilevered; and/or wherein the second cantilevered beam has a second portion thereof that is proximal and integrally fixed to the first structure, while the first portion is cantilevered.

9. The machine according to claim 6, wherein said pushing device comprises an actuator adapted to actuate a lever at a first end thereof, said lever being integral, at a second end thereof, with the rotating shaft onto which the upper roller is keyed.

10. The machine according to claim 6, wherein a pair of first rollers is provided on each of said two opposite inner sides of the first through hole.

11. The machine according to claim 6, wherein said first rollers have a convex side surface in contact with a respective side surface of the first cantilevered beam.

12. The machine according to claim 6, wherein said first rollers are idle, accommodated in respective seats obtained in the second structure and protruding into the first through hole to come into contact with mutually opposite surfaces of the first cantilevered beam; preferably, wherein the two side rollers and the possible lower roller of said second rollers are idle, accommodated in respective seats obtained in the second structure and protruding into the second through hole, while the upper roller is a driven roller, but idle to the rotation.

13. The machine according to claim 1, wherein there is provided at least one sensor, adapted to detect a difference in height between the head of the longitudinal metal product entering the welding machine and the tail of a further longitudinal metal product preceding said longitudinal metal product; and wherein there is provided a software, adapted to acquire a value of said difference in height and send a command to the second adjustment means to adjust the position of the second structure with respect to the first structure.

14. A welding method of the flash welding type for welding together a tail of a first longitudinal metal product to a head of a second longitudinal metal product fed along a feeding direction of said first and second longitudinal metal products, the method being performable by means of a machine according to claim 1 and comprising the following stages:
a) clamping the tail of the first longitudinal metal product or the head of the second longitudinal metal product by means of first clamping means provided on said first structure, and clamping the head of the second longitudinal metal product or the tail of the first longitudinal metal product by means of second clamping means provided on said second structure;
b) adjusting, by means of said second adjustment means, the position of the second structure with respect to the first structure by means of a lifting of the second structure along a plane transversal to said feeding direction, so as to align said tail and said head along the feeding direction;
c) welding said tail and said head by moving the second structure close to the first structure along said feeding direction, by means of said first adjustment means.

15. The method according to claim 14, wherein said lifting occurs by means of a rotation of the second structure about an axis C, parallel to the feeding direction, in a range between 1° and 5°, preferably between 1° and 3°.

16. The method according to claim 14 wherein the following stages are provided between stage a) and stage b):
detecting a difference in height, by means of at least one sensor, between the head of the longitudinal metal product entering the welding machine and the tail of a further longitudinal metal product preceding said longitudinal metal product;
acquiring a value of said difference in height and sending, by means of a software, a command to the second adjustment means to adjust the position of the second structure with respect to the first structure
